(19) United States
(12) Patent Application Publication
(10) Pub. No.: US 2026/0340269 A1
(43) Pub. Date: Oct. 29, 2026

(54) SYSTEMS AND METHODS FOR MULTIRECORD DATA POPULATION

(71) Applicant: ServiceNow, Inc., Santa Clara, CA (US)

(72) Inventors: Brian Javier Dyk, Ramat Gan (IL); Maor Cohen, Jerusalem (IL); Bina Sunil Patel, San Jose, CA (US)

(21) Appl. No.: 19/188,809

(22) Filed: Apr. 24, 2025

(51) Int. Cl. G06F 40/174; G06F 16/245; G06F 40/186

(52) U.S. Cl. CPC G06F 40/174; G06F 16/245; G06F 40/186

(57) ABSTRACT

A method including receiving one or more element identifiers associated with one or more elements of a user interface and receiving one or more mapping parameters. The one or more mapping parameters are indicative of an address associated with data used to populate the one or more element identifiers. The method also including generating a script that indicates respective associations between the one or more element identifiers and the one or more mapping parameters and executing the script to generate the one or more elements of the user interface.

### TECHNICAL FIELD

The present disclosure relates generally to a data population system. Specifically, the present disclosure relates to providing a framework to generate scripts to match and map elements within various software products across a platform of an enterprise.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Cloud computing services may allow for customization of applications and/or websites to foster engagement. For example, incorporation of customized input form screens to assist in receiving and organizing input data may generate dynamic user engagement. Mapping elements of input form screens to associated records to facilitate auto filling of data fields within customized input form screens can be tedious and time consuming. For example, an input form screen may include multiple elements associated with data entries, questionnaire responses, survey responses, menus, labels, buttons, and the like. Previously available techniques provide customization of input form screens by individually mapping each element to a single record (e.g., data source) and/or generating a series of element specific script based queries. That is, each element retrieves a value from different columns of the single record to populate input form screens. Mapping each element and generating element specific queries is computationally expensive and is associated with increased user time. Accordingly, new techniques for configuring mapping and retrieval related to data population within applications and/or websites are needed.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

A data population system is disclosed herein that provides a framework to improve techniques for mapping and retrieving data associated with one or more elements within software products of an enterprise. The data population system may be used to retrieve data associated with one or more data fields from multiple records, multiple rows of one or more tables, or a combination thereof using a single query. In this manner, the data population system may improve computational efficiency and reduces time spent by an organization’s user by simplifying element mapping and reducing database queries.

In certain aspects, the present disclosure is generally directed to a method. The method including receiving one or more element identifiers associated with one or more elements of a user interface and receiving one or more mapping parameters. The one or more mapping parameters are indicative of an address associated with data used to populate the one or more element identifiers. The method also including generating a script that indicates respective associations between the one or more element identifiers and the one or more mapping parameters and executing the script to generate the one or more elements of the user interface.

The present disclosure is directed to a system including processing circuitry and memory, accessible by the processing circuitry, the memory storing instructions that, when executed by the processing circuitry, cause the processing circuitry to perform operations. The operations include receiving one or more element identifiers associated with one or more elements of a user interface and receiving one or more mapping parameters. The one or more mapping parameters are indicative of an address associated with data used to populate the one or more element identifiers. The operations also include generating a script that indicates respective associations between the one or more element identifiers and the one or more mapping parameters and executing the script to generate the one or more elements of the user interface.

The present disclosure is directed to a non-transitory computer-readable storage medium including processor-executable routines that, when executed by a processor, cause the processor to perform operations. The operations include receiving one or more element identifiers associated with one or more elements of a user interface and receiving one or more mapping parameters. The one or more mapping parameters are indicative of an address associated with data used to populate the one or more element identifiers. The operations also include generating a script that indicates respective associations between the one or more element identifiers and the one or more mapping parameters and executing the script to generate the one or more elements of the user interface.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present techniques may operate;

FIG. 2 is a schematic diagram of an embodiment of a multi-instance cloud architecture in which embodiments of the present techniques may operate;

FIG. 3 is a block diagram of a computing device utilized in a computing system that may be present in FIGS. 1 or 2, in accordance with aspects of the present techniques;

FIG. 4 is a block diagram illustrating an embodiment in which a virtual server, which supports and enables the client instance, hosts a data population system, in accordance with aspects of the present techniques;

FIG. 5 is a schematic illustrating a framework of the data population system of FIG. 4 to be utilized within an enterprise, in accordance with aspects of the present techniques;

FIG. 6 is a schematic embodiment of the workflow of the data population system of FIG. 5, in accordance with the present disclosure;

FIG. 7 is a schematic embodiment of a screen of the data population system that utilizes an API illustrating a portion of the mapping parameters definition stage related to the workflow of the data population system of FIGS. 4 and 5, in accordance with aspects of the present techniques; and

FIG. 8 is a flow chart of a process of generating and executing a script via the data population system, in accordance with aspects of the present techniques.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers’ specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function(s) described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

In addition, as used herein, the terms “real time”, ”real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “automatic”, “automated”, “autonomous”, and so forth, are intended to describe operations that are performed or caused to be performed, for example, by a computing system (i.e., solely by the computing system, without human intervention). Indeed, although certain operations described herein may not be explicitly described as being performed automatically in substantially real time during operation of the computing system and/or equipment controlled by the computing system, it will be appreciated that these operations may, in fact, be performed automatically in substantially real time during operation of the computing system and/or equipment controlled by the computing system to improve the functionality of the computing system (e.g., by not requiring human intervention, thereby facilitating faster operational decision-making, as well as improving the accuracy of the operational decision-making by, for example, eliminating the potential for human error), as described in greater detail herein.

In modern communication networks, examples of cloud computing services include software as a service (SaaS) and platform as a service (PaaS) technologies. SaaS is a delivery model that provides software as a service rather than an end product. Instead of utilizing a local network or individual software installations, software is typically licensed on a subscription basis, hosted on a remote machine, and accessed by client devices as needed. For example, client devices are generally able to access a variety of enterprise and/or information technology (IT)-related software via a web browser. PaaS acts as an extension of SaaS that goes beyond providing software services by offering customizability and expandability features to meet a user’s needs. For example, PaaS can provide a cloud-based developmental platform for developing, testing, modifying, and/or customizing applications and/or automating enterprise operations without maintaining network infrastructure and/or allocating computing resources normally associated with these functions. These cloud computing services may provide applications and/or websites for user engagement. For example, cloud computing services may allow for customization of applications and/or websites to foster engagement. For example, incorporation of customized input form screens to assist in receiving and organizing input data may generate dynamic user engagement. Mapping elements of input form screens to associated records to facilitate auto filling of data fields within customized input form screens can be tedious and time consuming. For example, an input form screen may include multiple elements associated with data entries, questionnaire responses, survey responses, menus, labels, buttons, and the like. Mapping each element and generating element specific queries is computationally expensive and is associated with increased user time.

Accordingly, the presently disclosed techniques may be used to improve techniques for configuring mapping and retrieval related to populating data within software products of an enterprise. A data population system is disclosed herein that provides a framework to generate a script to match and map elements within applications and/or websites of a cloud based computing service of an enterprise. The data population system may execute the script to generate elements by retrieving data associated with each element mapped to each respective value. For example, the script may be used to retrieve data associated with one or more data fields from multiple records, multiple rows of one or more tables, or a combination thereof using a single query. In this manner, the data population system may reduce element specific queries and simplify mapping by offering a streamlined workflow to map multiple elements with associated records. For example, the data population system may be configured to provide a GUI or application that utilizes an application programming interface (API) to enable one or more elements of an interface to be associated with one or more element identifiers. The one or more element identifiers may be mapped to a respective record and field of one or more databases by defining mapping parameters associated with the element identifiers. Execution of the API may generate an input form screen including elements generated by retrieving data from the one or more databases using associated mapping parameters. By providing single query functionality, the data population system improves efficiency of computing resources and reduces time spent by an organization’s user and/or employees by simplifying element mapping and reducing database queries. Additionally, present embodiments include a graphical user interface (GUI) designed to enable element identification and script development to provide streamlined interface development in a concise and organized format.

In some embodiments, the data population system may initiate a workflow within the API to map and match the element identifiers with data stored as one or more data fields in one or more records, one or more tables, and the like. The workflow may include selecting the element identifiers, defining one or more mapping parameters, and executing the script. The element identifiers may be assigned to one or more elements of an interface. In some instances, one element identifier may correspond to one element of the interface. For example, the element identifiers may include one or more input fields (e.g., text fields, buttons, checkboxes, etc.), one or more output fields (e.g., icons, text fields, etc.), one or more navigational components (e.g., links, menus, pagination, search fields, etc.), one or more informational components (e.g., progress bars, notifications, etc.), and the like. The mapping parameters may be defined to associate the element identifiers with data from a data repository. As such, the mapping parameters may include one or more addresses to retrieve data from the data repository. In certain embodiments, the mapping parameters may be populated using a script template. The script template may be used to generate a single script to associate the element identifiers with respective addresses for data retrieval. In this manner, execution of the single script may generate a single query to provide customizable and streamlined data retrieval to enable multirecord data population.

Use of the disclosed techniques enables customization of applications and/or websites within an enterprise with improved computational efficiency. Accordingly, using the disclosed techniques, to enable multirecord data population via a single query may streamline mapping and matching elements to enable dynamic control of input form screen customization. For example, the single query generated by execution of the single script may be used to retrieve data associated with one or more data fields from multiple records, multiple rows of one or more tables, or a combination thereof. As a result, use of the data population system may reduce computational cost and reduce organization user time associated with mapping and matching elements for data retrieval.

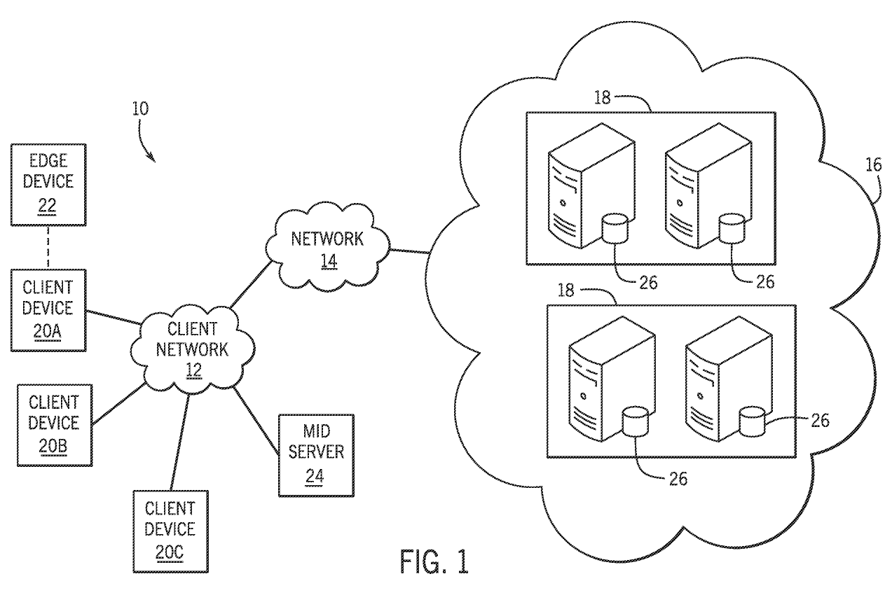

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In some implementations, the cloud-based platform 16 may be a configuration management database (CMDB) platform in which hardware, software, and/or other aspects of the client network 12 and/or cloud-based platform are regularly tracked and monitored. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, and 20B so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial device, server, or software-implemented agent, such as a management, instrumentation, and discovery server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 14. The network 14 may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to as application nodes, application servers, virtual server instances, application instances, or application server instances), where one or more virtual servers 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

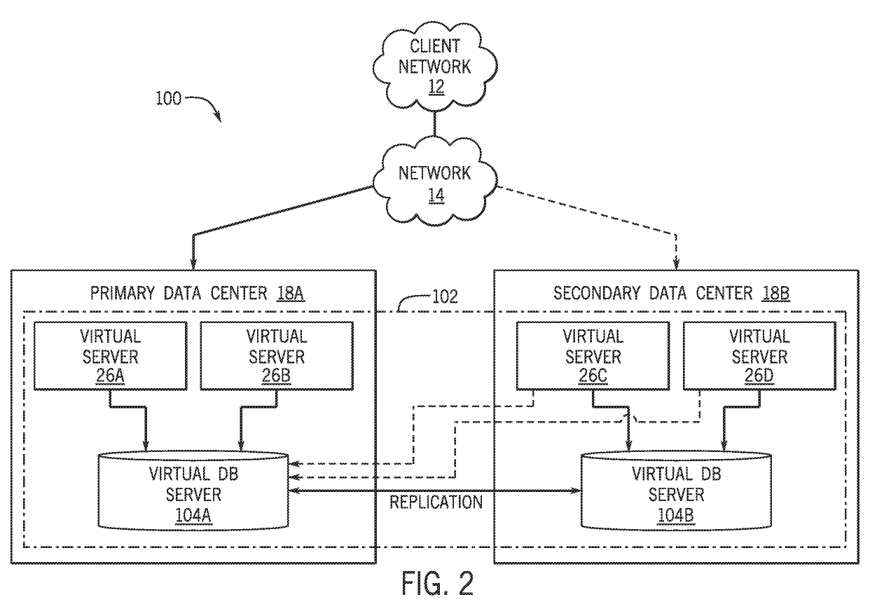

In another embodiment, one or more of the data centers 18 are configured using a multi-instance cloud architecture to provide every customer its own unique customer instance or instances. For example, a multi-instance cloud architecture could provide each customer instance with its own dedicated application server and dedicated database server. In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

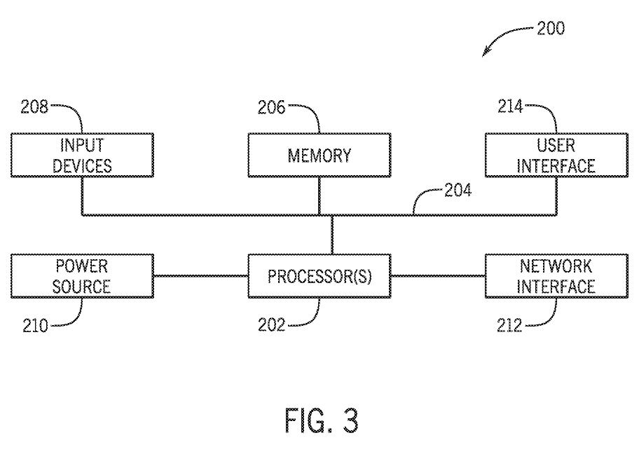

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 3, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition to and/or alternative to the display, the user interface 214 may include other devices for interfacing with a user, such as lights (e.g., LEDs), speakers, and the like.

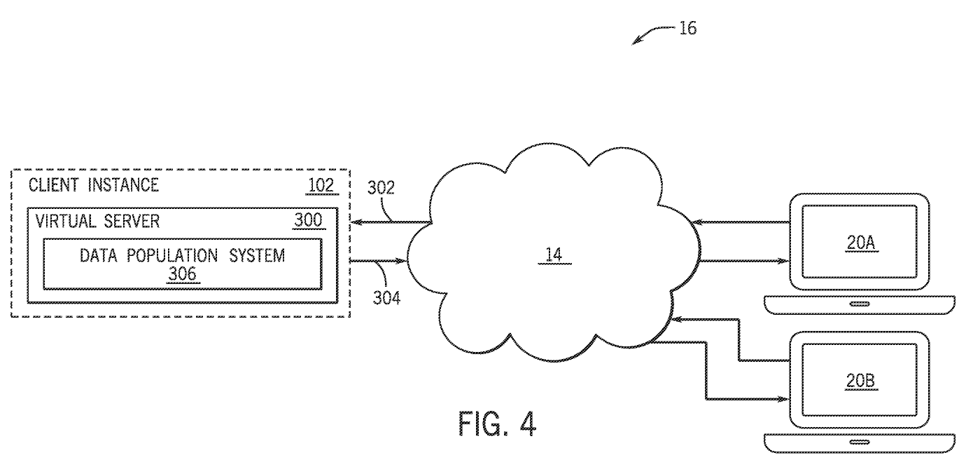

With the preceding in mind, FIG. 4 is a block diagram illustrating an embodiment in which a virtual server 300 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a first client device 20A (e.g., a developer device) and a second client device 20B (e.g., an end user device) via the network 14 to provide a user interface to network applications executing within the client instance 102 (e.g., via a web browser of the client device 20). Client instance 102 is supported by virtual servers 300 similar or identical to the virtual servers 26 explained with respect to FIG. 2 and is illustrated here to show support for the disclosed functionality described herein within the client instance 102. Cloud provider infrastructures are generally configured to support a plurality of end-user devices, such as client devices 20A, 20B, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with client instance 102 using an application that is executed within a web browser and/or a mobile application.

As shown, the first client device 20A and/or the second client device 20B may interact with the client instance 102 by providing inputs 302, to which the client instance 102 may respond with outputs 304. In the embodiment shown in FIG. 4, the virtual servers 300 of the client instance 102 may run a data population system 306, which may be a software application defined by code, accessible via a native application or web browser of the client device 20. Accordingly, the inputs 302 provided by the first client device 20A may include inputs requesting customization of input form screens, customization of pages of a user interface, and so forth. Additionally and/or alternatively, the inputs 302 provided by the second client device 20B may include user inputs in response to requests of input form screens, such as text, images, and the like. In some embodiments, the data population system 306 may be hosted by the client instance 102. The data population system 306 may be used to customize user interfaces of various software products, such as questionnaires, data input screens, and the like. The client instance 102 hosting the data population system 306 may be accessible via the first client device 20A and/or the second client device 20B. In some embodiments, use of the data population system 306 to enable data population from multiple records using a single query may be advantageous. For example, data may be retrieved using a single query from multiple records using the techniques described herein. In certain embodiments, use of the data population system 306 may enable data population from multiple records using various queries. For example, use of various queries may improve an efficiency of data retrieval by populating different elements of a screen from data originating from various unrelated tables using various queries. For example, the data population system 306 may execute two queries to populate data from two unrelated tables. As such, the data population system 306 may facilitate streamlined customization of user interfaces via the first client device 20A (e.g., the developer device) provided to users via the second client device 20B (e.g., the end user device) within applications and/or websites of the enterprise. In this manner, the data population system 306 may improve computational efficiency and reduce organizational user time associated with customizing and mapping elements provided on platforms and/or applications of the enterprise within the cloud provide infrastructures of the enterprise.

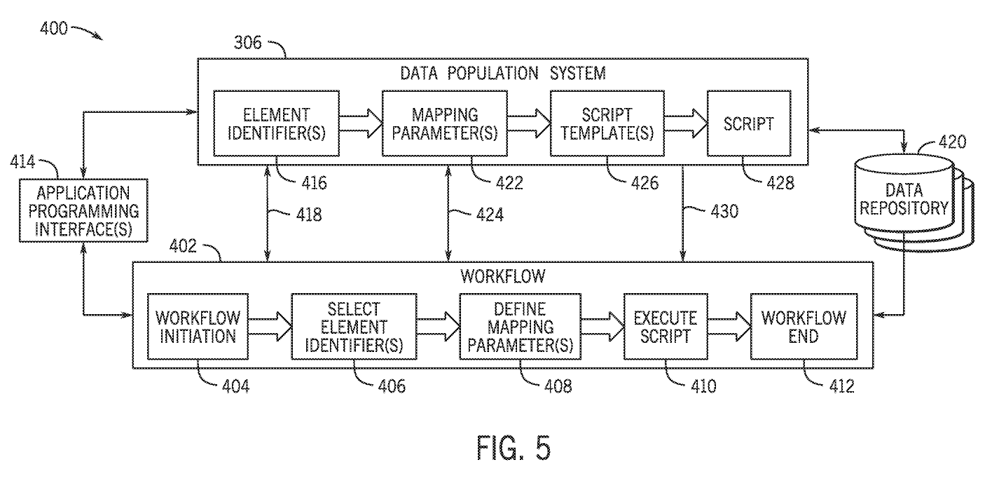

With this in mind, FIG. 5 is a framework 400 of a data population system 306 to be utilized within an enterprise. The data population system 306 may be used to perform a workflow 402 of an enterprise to provide customization of application and/or websites to foster engagement. The data population system 306 and the workflow 402 may be executed from the platform 16 of the enterprise. It should be noted, the framework 400 of FIG. 5 is one non-limiting example of the data population system 306 and the workflow 402 and that the illustrated stages are provided as examples and more, fewer, or different stages may be included in the framework 400 of the data population system 306 and workflow 402. Further, the data population system 306 and workflow 402 of the framework 400 may be executed by the client device 20, or any other suitable device(s) or controller(s).

In some embodiments, the workflow 402 may be used to improve efficiency of manual processes and digital functions of the enterprise. The workflow 402 may include a workflow initiation stage 404, an element identifiers selection stage 406, a mapping parameters definition stage 408, a script execution stage 410, and a workflow completion stage 412. The workflow initiation stage 404 may initiate execution of an application that utilizes an application programming interface (API) 414. The API 414 may be used to facilitate integration of the data population system 306 with one or more platforms of the enterprise. For example, organizational users (e.g., developers) may use the API 414 to improve customization of websites and/or application of the enterprise with increased granularity. Organizational users may customize an input field page display by associating element identifiers of a user interface with multiple records, without having to fully understand how such associations are built or presented. The API 414 may be based on one or more API protocols (e.g., simple object access protocol (SOAP), representational state transfer (REST), GOOGLE remote procedure call (gRPC), open data protocol (OData), GraphQL, and the like). In some embodiments, the API 414 may include one or more APIs configured to streamline implementation of the data population system 306.

The element identifiers selection stage 406 may initiate selection of one or more element identifiers 416. The element identifiers 416 may include one or more elements of a user interface (i.e., one element identifier corresponding to one element). For example, the element identifiers 416 may include one or more input fields, one or more output fields, one or more navigational components, one or more information components, or a combination thereof. In some embodiments, the element identifiers 416 may be selected based on identification of elements of the user interface that utilizes the API 414. For example, a first element identifier may be associated with a first input data field, a second element identifier may be associated with a second input data field, and a third element identifier may be associated with a first button of the user interface. In this manner, the first, second, and third element identifiers may serve as labels of the elements (first input data field, second input data field, and first button) of the user interface. In some embodiments, the element identifiers 416 may be provided to the data population system 306 as illustrated by arrow 418. Additionally and/or alternatively, the element identifiers 416 may be selected based on a recommendation generated by the data population system 306 (e.g., provided to the workflow 402 as illustrated by the arrow 418).

In some embodiments, the element identifiers selection stage 406 may identify element identifiers 416 associated with each element of the user interface or a subset of elements of the user interface. The element identifiers 416 may include information related to a type of element (e.g., input field, output field, navigational component, informational component, one or more additional types, and the like) associated with a respective element identifier, a location of the element within the user interface, additional associated data, or a combination thereof. The element identifiers 416 may be stored in one or more data repositories 420 associated with the data population system 306. As such, the element identifiers 416 of one or more of the elements of the user interface may be retrieved upon execution of the workflow initiation stage 404 of the workflow 402. That is, the element identifiers 416 may be stored and/or saved to enable the workflow 402 of the data population system 306 to be edited and/or restarted.

In some embodiments, the workflow 402 may progress to the mapping parameters definition stage 408. The mapping parameters definition stage 408 may include identifying one or more mapping parameters 422 associated with the element identifiers 416. The mapping parameters 422 may include one or more addresses associated with data in the data repositories 420. The mapping parameters 422 may be used to establish mapping between the element identifiers 416 and the data repository 420. For example, the mapping parameters 422 may include information related to data entries and/or attributes such as a record identifier, a table identifier, a column identifier, a row identifier, or a combination thereof. In this manner, the mapping parameters 422 may be used to associate (e.g., match) the element identifier 416 with one or more data fields from multiple records, multiple rows of one or more tables, or a combination thereof.

In some embodiments, the mapping parameters 422 may be provided to the workflow 402 as illustrated by arrow 424. Additionally and/or alternatively, the mapping parameters 422 may be stored in one or more data repositories 420 associated with the data population system 306. As such, the mapping parameters 422 mapped to the one or more element identifiers 416 may be retrieved upon execution of the workflow initiation stage 404 of the workflow 402. That is, the mapping parameters 422 may be stored and/or saved to enable the workflow 402 of the data population system 306 to be edited and/or restarted.

In certain embodiments, the mapping parameters 422 may be used to populate one or more script templates 426. The script templates 426 may be used to standardize data format and/or introduce template language. Such standardization may simplify use of the data population system 306 and may improve data mapping quality across the enterprise. The script templates 426 may interface with one or more APIs to facilitate modification of language of a display language, facilitate data formatting modifications, and the like. In some embodiments, the script templates 426 may include a data model used to represent a data structure. As such, the data structure defined by the script templates 426 may be used to assign each element identifier to a respective mapping parameter within a single query. In this manner, the script templates 426 may be used to consolidate one or more objects containing records from a single table to streamline data retrieval from one or more records, one or more tables, one or more columns, or a combination thereof in a single script.

In some embodiments, the script templates 426 may be used to generate a script 428 to be executed during the script execution stage 410 of the workflow 402. As such, the script 428 (e.g., a completed script template) may be provided to the workflow 402 as illustrated by arrow 430. It should be noted, in some embodiments, the script 428 may be generated without the use of the script templates 426. That is, the script 428 may be generated by directly associating the mapping parameters 422 to the element identifiers 416. The script 428 may be provided to the workflow 402 as illustrated by arrow 430.

In some embodiments, the workflow 402 may progress to the script execution stage 410. The script execution stage 410 may execute the script 428. Execution of the script 428 may retrieve data associated with the element identifiers 416 from the data repositories 420 via a single query. As compared to previously available techniques, use of the single query by the data population system 306 improves efficiency of computing resources by reducing queries to the data repositories 420. That is, the single query generated upon execution of the script 428 may reduce querying the data repositories 420 to retrieve data for each element of a user interface.

In certain embodiments, the script execution stage 410 of the workflow 402 may enable multirecord auto filling of the elements of the user interface associated with the element identifiers 416. For example, the data population system 306 may associate one or more elements of an input form screen with one or more input form element identifiers. The elements of the input form screen may include a series of answers to a questionnaire. As such, the input form element identifiers may correspond to each answer of the questionnaire. The input form element identifiers may be matched to one or more input form mapping parameters. The input form mapping parameters may be associated with multiple tables across different records. As such, each of the answers to the questionnaire or a subset of the answers to the questionnaire may be associated with a particular record. For example, a first answer may be associated with a first table of a first record, a second answer may be associated with a second table of a first record, a third answer may be associated with a first table of a second record, and the like. In this manner, a respective input form mapping parameter may be matched to each input form element identifiers. A script template may be used to map the respective inputs form mapping parameters to the input form element identifiers, generating an input form script. Execution of the input form script may be used to associate data received in the series of answers to the questionnaire to respective locations (e.g., records, tables, columns, data fields) of the data repositories 420. In this manner, the input form screen may be customized using a single query.

The workflow completion stage 412 of the workflow 402 may be initiated upon generation and/or execution of the script 428. As such, the workflow completion stage 412 may save the element identifiers 416, the mapping parameters 422, the script templates 426, the script 428, or a combination thereof in the data repositories 420 and/or one or more additional storage locations. In some embodiments, the workflow completion stage 412 may be initiated upon inactivity of the API 414. The API 414 may be restarted at any suitable stage of the workflow 402 to enable customization and/or editing of the element identifiers 416, the mapping parameters 422, the script templates 426, or the script 428 associated with a user interface of the enterprise.

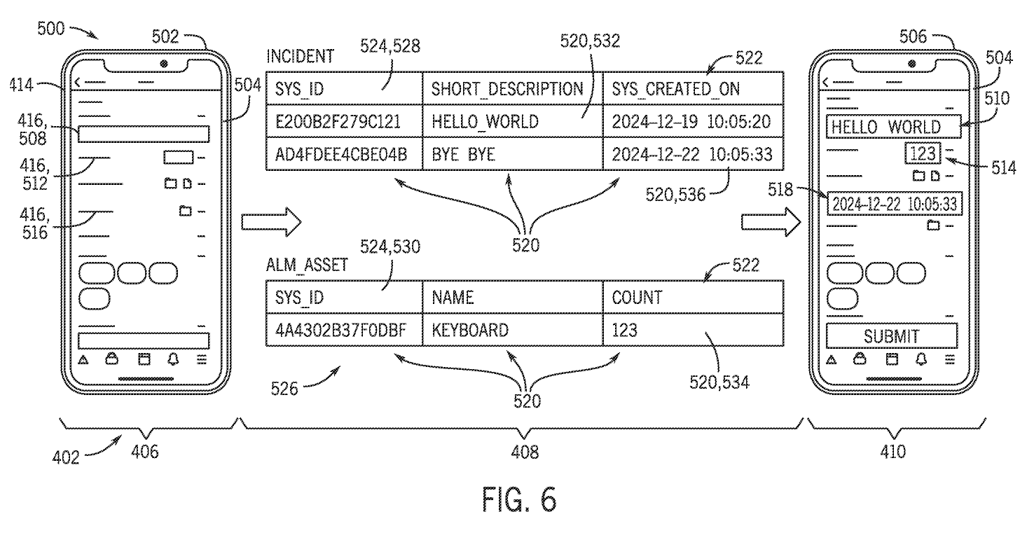

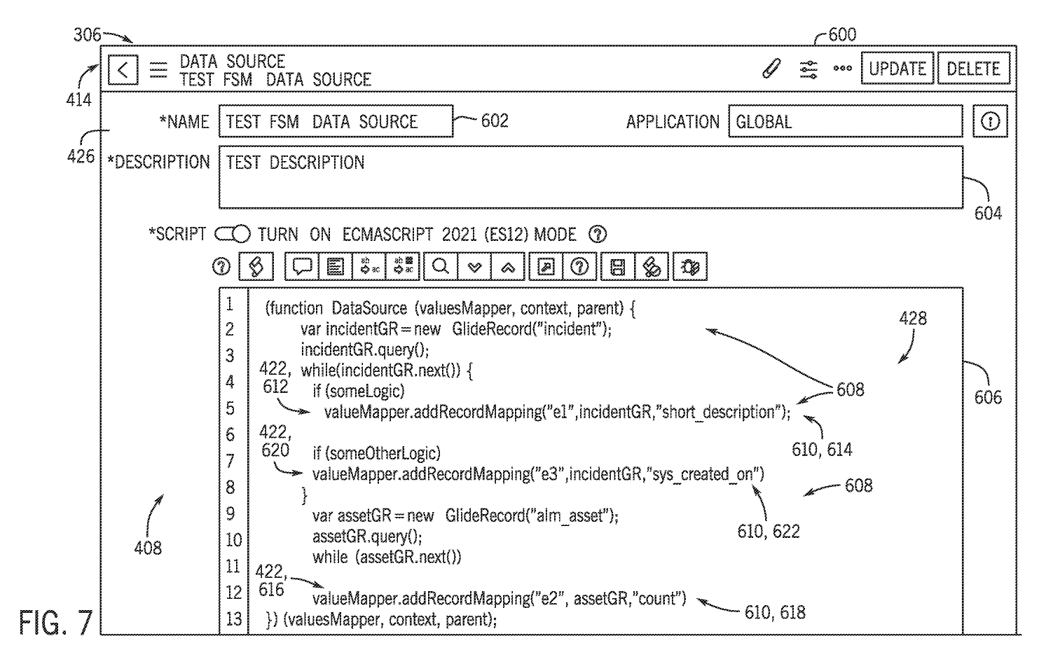

FIG. 6 is a schematic embodiment 500 of the workflow 402 of the data population system 306 of FIG. 5, in accordance with the present disclosure. FIG. 7 is a schematic embodiment of a screen 600 of the data population system 306 that utilizes an API 414 illustrating a portion of the mapping parameters definition stage 408 related to the workflow 402 of the data population system 306 of FIGS. 4 and 5, in accordance with aspects of the present techniques. To facilitate discussion, FIGS. 6 and 7 will be discussed below concurrently.

As shown, the data population system 306 may include an application that utilizes an API 414 and may run on a client device 502 (e.g., the first client device 20A shown in FIG. 4) or a client instance (e.g., client instance 102 shown in FIGS. 2 and 4) hosted a physical server or a virtual server (e.g., such as the servers 24 and 26 shown in FIGS. 1, 2, 4, and 5). The data population system 306 may be used by an organizational user (e.g., developer) to customize and/or edit elements of a user interface 504. The user interface 504 may be run on a client device 506 (e.g., the second client device 20B shown in FIG. 4), which may run on a virtual server (e.g., the virtual server 26 shown in FIGS. 1, 2, and 4). It should be understood, however, that the schematic embodiment 500 shown in FIG. 6 is merely one embodiment and that other embodiments are envisaged in which one or more components shown in FIG. 6 may be hosted on one or more additional instances.

The schematic embodiments 500 includes an illustrative example of the element identifiers selection stage 406, the mapping parameters definition stage 408, and the script execution stage 410 of the workflow 402. It should be noted, one or more additional stages may be performed by the data population system 306. The element identifiers selection stage 406 includes identifying one or more element identifiers 416 associated with elements of the user interface 504. That is, the element identifiers 416 may be used to tag and/or label elements of the user interface 504. A first element identifier 416, 508 corresponds to a first element 510 of the user interface 504. The second element identifier 416, 512 corresponds to a second element 514 of the user interface 504. The third element identifier 416, 516 corresponds to a third element 518 of the user interface 504. The first element 510 of the user interface 504 is a title field, the second element 514 is a numerical field, and the third element 518 is a date picker filed. It should be noted one or more additional elements may be tagged such as an object field, an image field, a document field, and the like.

Upon identification of the element identifiers 416 of the user interface 504, the workflow 402 may initiate the mapping parameters definition stage 408. The mapping parameters definition stage 408 may be used to define one or more mapping parameters 422. The mapping parameters 422 may be used to match and map the element identifiers 416 with one or more data fields 520 of one or more columns 522 stored in one or more tables 524 of a record 526. The record 526 may be stored in one or more data repositories (e.g., the data repositories 420 shown in FIG. 5). As shown, each of the element identifiers 416 may be matched to a respective data field within a particular column of a particular table. As a non-limiting example, the tables 524 may include an incident table 524, 528 and an asset table 524, 530. The first element identifier 416, 508 may be mapped to a first data field 520, 532 of the incident table 524, 528. The second element identifier 416, 512 may be mapped to a first data field 520, 534 of the asset table 524, 530. The third element identifier 416, 516 may be mapped to a second data field 520, 536 of the incident table 524, 528. In this manner, the element identifiers 416 may be matched and mapped to respective mapping parameters 422.

In some embodiments, the data population system 306 may generate one or more screens to receive one or more mapping parameters 422 associated with the mapping parameters definition stage 408 to match and/or map the element identifier 416 to respective data fields 520. Referring now to FIG. 7, the screen 600 of the data population system 306 may include a script template 426. The script template 426 may be used to associate the mapping parameters 422 with the element identifiers 416. The script template 426 may include a title field 602, a description field 604, a fillable script 606 (e.g., one or more fillable fields), and one or more additional components. In some embodiments, one or more portions of the fillable script 606 may be auto populated by the data population system 306 based on selection of the element identifiers 416. In other embodiments, the fillable script 606 may be populated by a user of the data population system 306.

In some embodiments, the script template 426 may include one or more portions of code 608 that may be used to map the element identifiers 416 with the mapping parameters 422. For example, the portions of code 608 may include reference to the record 526, the table 524, and the column 522 providing respective addresses 610 for each element identifier to respective data fields 520. As shown, the first element identifier 416, 508 is associated with a first mapping parameter 422, 612 indicative of a first address 610, 614 of the first data field 520, 532 of the incident table 524, 528 of FIG. 6. The second element identifier 416, 512 is associated with a second mapping parameter 422, 616 indicative of a second address 610, 618 of the first data field 520, 534 of the asset table 524, 530 of FIG. 6, and the third element identifier 416, 516 is associated with a third mapping parameter 422, 620 indicative of a third address 610, 622 of the second data field 520, 536 of the incident table 524, 528 of FIG. 6. The addresses 610 (e.g., code referencing a respective record, table, and column) form a script 428 that may be run by the data population system 306.

Returning to FIG. 6, the data population system 306 may initiate the script execution stage 410 of the workflow 402. The script execution stage 410 may run the script 428 shown in FIG. 7 to associate the elements 510, 514, 518 of the user interface 504 with the respective data fields 520. The script 428 may facilitate multirecord data population using a single query. In this manner, the data repositories associated with the data fields 520 may be queried via a single request to reduce computational cost of multirecord data population. Elements of the user interface 504 may be simultaneously populated from multiple data fields 520, columns 522, tables 524, and/or records 526. For, the first element 510 may be populated with a title, “Hello world,” the second element 514 may be populated with a numerical value, “123,” and the third element 518 of the user interface 504 may be populated with a date, “Dec.-22, 2024 10:05:33.” The data population system 306 provides customizable and streamlined data retrieval to enable multirecord data population. It should be noted, that FIGS. 6 and 7 provide non-limiting embodiments and one or more elements associated with one or more additional user interfaces may be populated by the data population system 306.

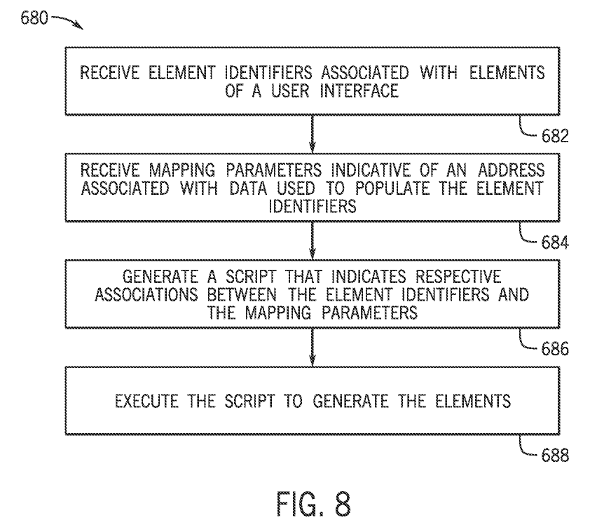

FIG. 8 is a flow chart of a process 680 of the data population system 306. The process 680 may be performed by the client device 20, a computing device or controller disclosed above with reference to FIG. 1 or any other suitable computing device(s) or controller(s). Furthermore, the blocks of the process 680 may be performed in the order disclosed herein or in any suitable order. For example, certain blocks of the process may be performed concurrently. In addition, in certain embodiments, at least one of the blocks of the process 680 may be omitted.

At block 682 of the process 680, the data population system 306 may receive one or more element identifiers associated with one or more elements of a user interface. The element identifiers may be used to tag and/or identify elements of the user interface such as input data fields, output data field, navigational components, information components, and the like. For example, the user interface may include one or more checkbox elements. As such, an element identifier may be associated with each checkbox element of the user interface.

At block 684 of the process 680, the data population system 306 may receive one or more mapping parameters indicative of an address associated with data used to populate the one or more element identifiers. The mapping parameters may include an address to map the element identifier to data of one or more tables, records, columns, or fields. For example, the mapping parameters may be used to associate properties of the checkbox elements (e.g., checked, unchecked) to data fields within various tables and records.

At block 686 of the process 680, the data population system 306 may generate a script that indicates respective associations between the one or more element identifiers and the one or more mapping parameters. The script may be generated based on a script template generated by the data population system 306. The script template may include one or more fillable fields. The one or more fillable fields may be executed by a user and/or automatically generated by the data population system 306. The script may include one or more portions of code including the mapping parameters of each respective element identifier. In this manner, the script may include the addresses (e.g., location) of data associated with the checkbox elements of the user interface.

In some embodiments, the data population system 306 may execute the script to generate the one or more elements. Execution of the script may include a single query to one or more databases. The single query may be processed by the databases by translating the script into a database-specific query language (e.g., structured query language). The single query, including requests for data associated with each element identifier, may be fulfilled by the database in a single response. In this way, the data population system 306 may streamline database querying, enabling multifield data population of the element of the user interface without necessitating creation of separate and distinct database queries for each element. As such, the data population system 306 may offer customization of user interfaces while maintaining and/or improving computational efficiency of user interfaces of the enterprise.

The present disclosure is directed to a data population system 306 to streamline techniques for configuring mapping and retrieval related to data population within software products of an enterprise. In this manner, the data population system 306 may provide a framework to generate a script to match and map elements within applications and/or websites of a cloud based computing service of an enterprise using one or more element identifiers. The data population system 306 may also implement customization within software products through the use of one or more script templates. Script templates may be used to simplify data mapping through the use of a standard data format and/or language. In this manner, the data population system 306 provides streamlined design of user interfaces of the enterprise. Integration of the data population system 306 on the platform of the enterprise allows increased user control and customization during development, deployment, and/or maintenance of various elements integrated within software products while reducing an amount of database queries. Previously, customization of user interfaces included mapping each element to a single record (e.g., each element retrieves a value from one or more columns of the single record) and/or generating a series of element specific script based queries. By reducing an amount of element specific script based queries through incorporation of the data population system 306 and providing a means for retrieving data from different columns of distinct records, computational efficiency of software products of the enterprise may be improved.

Technical effects of the disclosed techniques include use of the data population system 306 to provide improved user interface customization of various platforms hosted by software products of an enterprise. The data population system 306 may include various stages such as a workflow initiation stage, an element identifiers selection stage, a mapping parameters definition stage, a script execution stage, and a workflow completion stage. The data population system 306 may result in reduced computational costs associated with less time spent manually mapping each element of a user interface to a respective data field.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]…” or “step for [perform]ing [a function]…”, it is intended that such elements are to be interpreted under 35 U.S.C. 112(f). However, for any claims containing elements designated in any other manner, it is intended that such elements are not to be interpreted under 35 U.S.C. 112(f).

1. A method comprising:
receiving one or more element identifiers associated with one or more elements of a user interface;
receiving one or more mapping parameters that include information regarding populating the one or more element identifiers;
generating a script that indicates respective associations between the one or more element identifiers and the one or more mapping parameters; and
executing the script to generate one or more elements of the user interface.

2. The method of claim 1, wherein the one or more mapping parameters are indicative of an address associated with data used to populate the one or more element identifiers, and wherein the address comprises a location of a record and a field of one or more databases.

3. The method of claim 1, wherein the one or more elements of the user interface comprise one or more data fields.

4. The method of claim 1, further comprising:
generating a script template comprising one or more fillable fields; and
populating the one or more fillable fields with the one or more mapping parameters.

5. The method of claim 1, further comprising transmitting, to a client device, data indicative of one or more elements of the user interface.

6. The method of claim 1, wherein the script to generate the one or more elements of the user interface comprises generating a single query.

7. The method of claim 1, wherein executing the script comprises retrieving data from one or more data fields of one or more records.

8. The method of claim 1, further comprising populating the one or more elements simultaneously.

9. The method of claim 1, wherein the user interface is an input form screen.

10. The method of claim 1, wherein the elements of the user interface comprise one or more input fields, one or more output fields, one or more navigational components, one or more information components, or a combination thereof.

11. A system, comprising:
one or more processors; and
a non-transitory memory storing instructions that, when executed by the one or more processors, cause the one or more processors to perform operations comprising:
receiving one or more element identifiers associated with one or more elements of a user interface;
receiving one or more mapping parameters, wherein the one or more mapping parameters are indicative of an address associated with data used to populate the one or more element identifiers;
generating a script that indicates respective associations between the one or more element identifiers and the one or more mapping parameters; and
executing the script to generate the one or more elements of the user interface.

12. The system of claim 11, wherein the address comprises a location of a record and a field of one or more databases.

13. The system of claim 11, wherein the one or more elements of the user interface comprise one or more data fields.

14. The system of claim 11, wherein the one or more processors performs operations comprising:
generating a script template comprising one or more fillable fields; and
populating the one or more fillable fields with the one or more mapping parameters.

15. The system of claim 11, wherein the one or more processors performs operations comprising:
transmitting, to a client device, data indicative of one or more elements of the user interface.

16. A non-transitory computer-readable storage medium, comprising processor-executable routines that, when executed by a processor, cause the processor to perform operations comprising:
receiving one or more element identifiers associated with one or more elements of a user interface;
receiving one or more mapping parameters, wherein the one or more mapping parameters are indicative of an address associated with data used to populate the one or more element identifiers;
generating a script that indicates respective associations between the one or more element identifiers and the one or more mapping parameters; and
executing the script to generate the one or more elements of the user interface.

17. The non-transitory computer-readable storage medium of claim 16, wherein the address comprises a location of a record and a field of one or more databases.

18. The non-transitory computer-readable storage medium of claim 16, wherein the one or more elements of the user interface comprise one or more data fields.

19. The non-transitory computer-readable storage medium of claim 16, wherein the processor performs operations comprising:
generating a script template comprising one or more fillable fields; and
populating the one or more fillable fields with the one or more mapping parameters.

20. The non-transitory computer-readable storage medium of claim 16, wherein the processor performs operations comprising transmitting, to a client device, data indicative of one or more elements of the user interface.
